(19) United States
(12) Patent Application Publication
(10) Pub. No.: US 2026/0077463 A1
(43) Pub. Date: Mar. 19, 2026

(54) FASTENER DRIVER

(71) Applicant: Nanjing Chervon Industry Co., Ltd., Nanjing (CN)

(72) Inventors: Guangcheng Sun, Nanjing (CN); Hongbin Wang, Nanjing (CN); Xiaobo Yu, Nanjing (CN); Guang Li, Nanjing (CN); Xianjing Shao, Nanjing (CN); Qi Du, Nanjing (CN); Honglei Zhao, Nanjing (CN)

(21) Appl. No.: 19/394,030

(22) Filed: Nov. 19, 2025

Related U.S. Application Data
(63) Continuation of application No. PCT/CN2025/091402, filed on Apr. 27, 2025.

(30) Foreign Application Priority Data
May 13, 2024 (CN) 202421034071.9
May 13, 2024 (CN) 202421035408.8
May 14, 2024 (CN) 202410599138.1

(51) Int. Cl. B25C 1/04; B25C 1/06

(52) U.S. Cl. CPC B25C 1/047; B25C 1/06

(57) ABSTRACT

A fastener driver includes a first cylinder including first cylinder holes through which the external gas is replenished into the first cylinder; and a second cylinder including second cylinder holes through which the gas in the second cylinder is released to the outside. The first cylinder communicates with the second cylinder. A first piston is disposed in the first cylinder. When a striking member is at a stop position, the air pressure on one side of the first piston is different from the air pressure on the other side of the first piston.

### RELATED APPLICATION INFORMATION

This application is a continuation of International Application Number PCT/CN2025/091402, filed on Apr. 27, 2025, through which this application also claims the benefit under 35 U.S.C. § 119(a) of Chinese Patent Application No. 202410599138.1, filed on May 14, 2024, Chinese Patent Application No. 202421035408.8, filed on May. 13, 2024, and Chinese Patent Application No. 202421034071.9, filed on May. 13, 2024, which applications are incorporated herein by reference in their entireties.

### TECHNICAL FIELD

The present application relates to a handheld power tool, for example, a fastener driver.

### BACKGROUND

The nail gun in the related art is a fastener driver for quickly driving nails into a working surface. A compressed air-driven nail gun has a compressed air-driven cylinder, and the thrust generated by the cylinder is used as a driving force. A mechanical spring-loaded nail gun has an impact spring (compression spring), and the force of the impact spring is used as a driving force.

In the related art, whether it is a mechanical spring-loaded nail gun or a gas spring nail gun, the force of the spring that stores energy drives a striking member to drive a fastener into a workpiece. The normal operation of the striking member ensures the operation state of the whole machine.

A compressed air-driven nail gun (gas spring nail gun) has a compressed air-driven cylinder, and the thrust generated by the cylinder is used as a driving force. A mechanical spring-loaded nail gun has an impact spring (compression spring), and the force of the impact spring is used as a driving force. For the compressed air-driven nail gun, when the strike is started, one compression stroke is required to store energy in the cylinder. When the stored energy satisfies the requirement, the energy is released to drive the striking member to perform striking.

This part provides background information related to the present application, and the background information is not necessarily the existing art.

### SUMMARY

A fastener driver includes: a striking assembly including a striking member that moves from a stop position to a striking position to strike a fastener; and a power mechanism including a gas spring mechanism for driving the striking member. The gas spring mechanism includes at least: a first cylinder including first cylinder holes through which the external gas is replenished into the first cylinder; and a second cylinder including second cylinder holes through which the gas in the second cylinder is released to the outside. The first cylinder communicates with the second cylinder. A first piston is disposed in the first cylinder. When the striking member is at the stop position, the air pressure on one side of the first piston is different from the air pressure on the other side of the first piston.

In some examples, when the striking member is at the stop position, the first piston remains stationary relative to the first cylinder.

In some examples, the first piston includes a working side configured to be in contact with the gas in the first cylinder and a communication side exposed to the outside, and when the striking member is at the stop position, the air pressure on the working side of the first piston is greater than the air pressure on the communication side of the first piston.

In some examples, the power mechanism further includes an electric motor that rotates about a motor axis to move the first piston within the first cylinder.

In some examples, a controller for controlling the operation of the electric motor is further included, where after receiving a shutdown signal, the controller is configured to control the electric motor to respond to the shutdown signal at least after gas is replenished from the outside into the first cylinder through the first cylinder holes.

In some examples, a signal generation device configured to generate the shutdown signal is further included.

In some examples, when the signal generation device generates the shutdown signal, the external gas is replenished into the first cylinder through the first cylinder holes.

In some examples, when the signal generation device generates the shutdown signal, the first piston at least starts to compress gas in the first cylinder.

In some examples, the signal generation device is disposed in a transmission path from the electric motor to the gas spring mechanism.

In some examples, the signal generation device is disposed in a transmission path from the gas spring mechanism to the striking member.

In some examples, the first piston is driven by the electric motor to move, and the stop position of the first piston is related to the shutdown position or shutdown time of the electric motor.

In some examples, when the signal generation device sends the shutdown signal, the controller controls the number of rotations of the electric motor.

In some examples, when the number of rotations of the electric motor reaches a preset value, the pressure generated through the compression stroke of the first piston for the gas in a first cylinder cavity satisfies a pre-pressure threshold.

In some examples, when the signal generation device sends the shutdown signal, the controller controls at least one of the rotation time of the electric motor or the rotation angle of a motor shaft.

In some examples, part of the gas in a second cylinder cavity is released to the outside through the second cylinder holes in the case where the striking member is at the striking position.

A fastener driver includes: a striking assembly including a striking member that moves from a stop position to a striking position to strike a fastener; and a power mechanism including a gas spring mechanism for driving the striking member. The gas spring mechanism includes at least: a first cylinder including first cylinder holes through which the external gas is replenished into the first cylinder; and a second cylinder including second cylinder holes through which the gas in the second cylinder is released to the outside. The first cylinder communicates with the second cylinder. A first piston is disposed in the first cylinder. When the striking member is at the stop position and waits for the next strike, the first piston pre-compresses the gas in a first cylinder cavity.

In some examples, when the striking member is at the stop position, the first piston remains stationary relative to the first cylinder.

In some examples, the first piston includes a working side configured to be in contact with the gas in the first cylinder and a communication side exposed to the outside, and when the striking member is at the stop position, the air pressure on the working side of the first piston is greater than the air pressure on the communication side of the first piston.

In some examples, the power mechanism further includes an electric motor that rotates about a motor axis to move the first piston within the first cylinder.

In some examples, a controller for controlling the operation of the electric motor is further included, where after receiving a shutdown signal, the controller is configured to control the electric motor to respond to the shutdown signal at least after gas is replenished from the outside into the first cylinder through the first cylinder holes.

A fastener driver includes: a striking assembly including a striking member configured to strike a fastener; and a power mechanism including a gas spring mechanism for driving the striking member. The gas spring mechanism includes at least: a striking cylinder in which a striking piston is disposed, where the striking member is fixed to an end of the striking piston; and an energy storage cylinder disposed outside the striking cylinder and communicating with an end of the striking cylinder, where when driven by a drive assembly, the compressed gas capable of unlocking the striking piston is formed in the energy storage cylinder. When the striking member is in a stop state, a side of the striking piston communicates with the outside, a sealed space is formed on the other side of the striking piston, the sealed space has an initial state and a final state, and when the sealed space is in the final state, the striking piston is in a locked state. The ratio of the difference between the volume of the sealed space in the initial state and the volume of the sealed space in the final state to the volume of the sealed space in the initial state is greater than or equal to 0 and less than or equal to 0.8.

In some examples, the ratio of the difference between the volume of the sealed space in the initial state and the volume of the sealed space in the final state to the volume of the sealed space in the initial state is greater than or equal to 0 and less than or equal to 0.5.

In some examples, the fastener driver further includes a third piston, where the third piston is disposed at an end of the striking piston, and when the striking piston is in the locked state, an inner wall of the striking cylinder is in sealing contact with the third piston at a sealing contact position.

In some examples, the distance from a front end surface of the inner wall of the striking cylinder to a rear end surface of the striking piston is less than the distance from the sealing contact position to the rear end surface of the striking piston.

In some examples, with the sealing contact position as the vertex of an included angle α, the included angle α between the third piston and an inner wall surface of the striking cylinder along a striking direction is less than 90°.

In some examples, the striking cylinder includes a first cylinder portion and a second cylinder portion that are connected; the inner diameter of the first cylinder portion is greater than the inner diameter of the second cylinder portion; and when the striking piston is in the locked state, the striking piston is located in the first cylinder portion, and the third piston is located in the second cylinder portion.

In some examples, the striking cylinder further includes a third cylinder portion connected between the first cylinder portion and the second cylinder portion, and when the sealed space is in the initial state, the sealing contact position is located at an end of the third cylinder portion facing the second cylinder portion.

In some examples, the fastener driver further includes a second sealing member sleeved on the third piston, where the second sealing member is in sealing contact with the inner wall of the striking cylinder at the sealing contact position.

In some examples, the third piston is provided with an annular groove around the axis of the third piston, the second sealing member is located in the annular groove, and the second sealing member is movable in the annular groove along the axis of the third piston and stoppable on two opposite sidewalls of the annular groove.

In some examples, a rear end surface of the striking piston is recessed in a striking direction to form a recessed space, and the recessed space communicates with the sealed space.

In some examples, a magnetic attraction member is disposed on an inner wall of the striking cylinder which forms the sealed space, and a magnetic force generated by the magnetic attraction member is used for adsorbing the striking piston and keeping the striking piston in the locked state.

In some examples, the compressed gas is capable of overcoming the magnetic force to unlock the striking piston.

A fastener driver includes: a striking assembly including a striking member configured to strike a fastener; and a power mechanism including a gas spring mechanism for driving the striking member. The gas spring mechanism includes at least: a striking cylinder in which a striking piston is disposed, where the striking member is fixed to an end of the striking piston; and an energy storage cylinder disposed outside the striking cylinder and communicating with an end of the striking cylinder, where when driven by a drive assembly, the compressed gas capable of unlocking the striking piston is formed in the energy storage cylinder. When the striking member is in a stop state, the striking piston is in a locked state, a side of the striking piston communicates with the outside, and the other side of the striking piston also communicates with the outside.

In some examples, the fastener driver further includes: a first sealing member disposed on the striking piston; a third piston fixed to the other end of the striking piston; and a second sealing member disposed on the third piston; where a throttle orifice is disposed on the first sealing member.

In some examples, the throttle orifice includes a fracture on the first sealing member.

In some examples, the opening extension direction of the fracture on the first sealing member is not parallel to the axial direction of the first sealing member.

In some examples, the throttle orifice includes a groove on the outer circumference of the first sealing member.

In some examples, the opening extension direction of the groove on the first sealing member is not parallel to the axial direction of the first sealing member.

In some examples, the fastener driver further includes a piston valve disposed on the striking piston, where the piston valve is configured to allow gas on the side of the striking piston communicating with the outside to flow to the other side of the striking piston.

In some examples, the piston valve is configured to be a one-way throttle valve.

In some examples, the piston valve is configured to be a Tesla valve.

In some examples, an exhaust channel is disposed on the inner wall of the first cylinder, and when the first piston is in the locked state, the other side of the first piston communicates with the outside through the exhaust channel.

### BRIEF DESCRIPTION OF THE DRAWINGS

FIG. 1 is a structural view of a fastener driver according to an example of the present application.

FIG. 2 is a partial schematic view of internal structures of the fastener driver in FIG. 1.

FIG. 3 is a sectional view of some structures of the fastener driver in FIG. 1, where a striking member is at a stop position.

FIG. 4 is a sectional view of the fastener driver in FIG. 1, where a striking member is at a striking position.

FIG. 5 is a sectional view of the fastener driver in FIG. 1, where a striking member is at a stop position and an electric motor shuts down.

FIG. 6 is a circuit diagram of a fastener driver according to an example of the present application.

FIG. 7 is an exploded view of a drive assembly according to an example of the present application.

FIG. 8 is a sectional view of a gas spring mechanism and a firing assembly according to a second example of the present application.

FIG. 9 is a schematic view of some structures in FIG. 8.

FIG. 10 is a structural view of a striking piston with a recessed space according to an example of the present application.

FIG. 11 is a sectional view of a one-way exhaust valve according to an example of the present application.

FIG. 12 is a partial sectional view of a gas spring mechanism and a firing assembly according to a third example of the present application.

FIG. 13 is a schematic view of some structures in FIG. 12.

FIG. 14A is a structural view of a first sealing member with a fracture from a first perspective according to an example of the present application.

FIG. 14B is a structural view of a first sealing member with a fracture from a second perspective according to an example of the present application.

FIG. 15A is a structural view of a first sealing member with a groove from a first perspective according to an example of the present application.

FIG. 15B is a structural view of a first sealing member with a groove from a second perspective according to an example of the present application.

FIG. 16 is a sectional view of a first piston with a piston valve according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or”relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies [symbol] one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

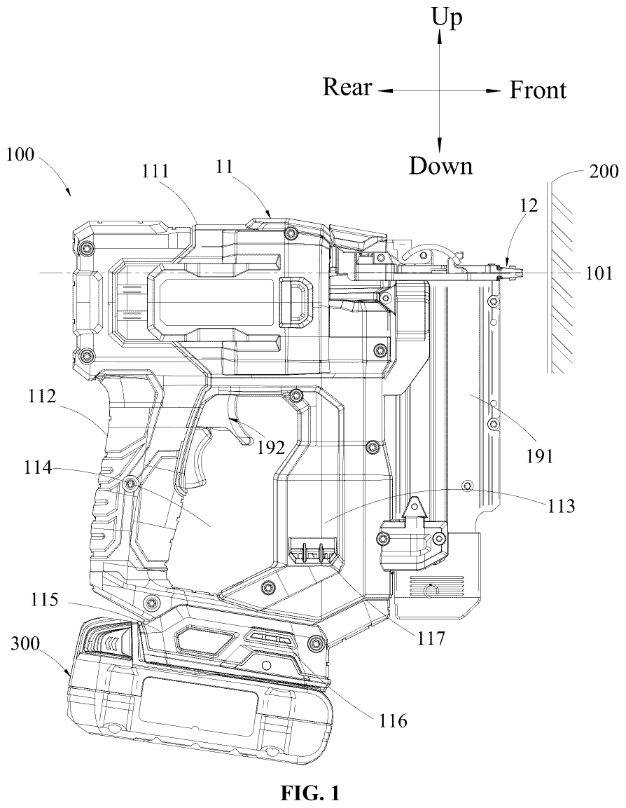

FIG. 1 shows a fastener driver 100 according to an example of the present application. The fastener driver 100 is used for driving a fastener into a working surface 200. For example, the fastener is a nail, and the nail may be a straight nail or a U-shaped nail. The fastener driver 100 quickly drives the fastener into the working surface 200, thereby fixing the working surface 200 to the platform on the back side of the working surface 200. In this example, the fastener driver 100 is, for example, a nail gun. Optionally, the fastener driver 100 includes a mechanical spring-loaded nail gun that utilizes the force of a compressed coil spring as an impact force (for example, a drive force). Optionally, the fastener driver 100 is a cylinder-type nail gun that compresses gas in a cylinder so that the gas pushes out a firing assembly to apply an impact force (for example, a drive force) for driving a nail.

In this example, the fastener driver 100 is a cylinder-type nail gun. For example, a cylinder assembly of the fastener driver 100 communicates with the atmosphere, and in the preset state, the gas flows into the cylinder.

As shown in FIG. 1, a rechargeable battery set is used as a power supply for the fastener driver 100. In this example, the battery set is a battery pack 300, and the battery pack 300 mates with a corresponding power circuit to supply power to the fastener driver 100. It is to be understood by those skilled in the art that, in other examples, the fastener driver 100 may be powered by other power supply devices. For example, the power supply may be an alternating current wire connected to mains electricity or another connection cable that can be connected to power supply equipment. The corresponding components in the fastener driver 100 are powered through the mains electricity or another power supply equipment in collaboration with corresponding rectifier, filter, and voltage regulator circuits. The battery pack 300 is used below instead of the power supply, which is not to limit the present application.

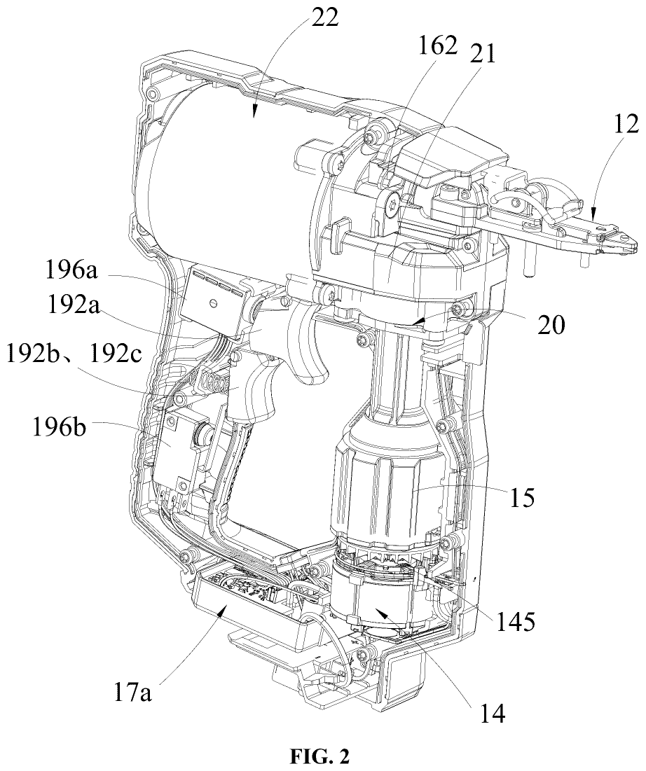

As shown in FIGS. 1 to 3, the fastener driver 100 includes a housing 11, a striking assembly 12, and a power mechanism 20. The housing 11 is used for supporting the striking assembly 12 and the power mechanism 20. The striking assembly 12 includes a striking member 121 for driving the fastener. Optionally, the striking member 121 is used for driving the fastener into the working surface 200 along the direction of a striking straight line 101. The striking member 121 is a sheet element extending along a plane parallel to the direction of the striking straight line 101, and the axis defined by the striking member 121 coincides with the striking straight line 101. The power mechanism 20 is used for driving the striking member 121 to move along the direction of the striking straight line 101, thereby impacting and driving the fastener into the working surface 200 along the direction of the striking straight line 101.

In this example, the striking member 121 includes a stop position, that is, a top dead center, and a striking position, that is, a bottom dead center. For example, the power mechanism 20 drives the striking member 121 so that the striking member 121 moves from the stop position to the striking position to impact the fastener, and after striking the fastener, the striking member 121 returns from the striking position to the stop position, thereby completing one strike. That is, under normal circumstances, when the striking member 121 moves from the stop position to the striking position, the striking member 121 drives the fastener into the working surface 200 along the direction of the striking straight line 101. Then, the striking member 121 returns from the striking position to the initial stop position to wait for the next strike.

To conveniently describe the technical solutions of the present application, the front and rear direction and the up and down direction are defined as shown in FIG. 1. The front and rear direction is parallel to the striking straight line 101, the direction from the striking member 121 to the fastener is the front, and the up and down direction is perpendicular to the front and rear direction.

In this example, the power mechanism 20 further includes a motor 14. The motor 14 is disposed in the housing 11 and used for providing power. In this example, the motor 14 is specifically an electric motor 14, and the electric motor 14 provides power. The electric motor 14 rotates about a motor axis 104 to generate a force that moves the striking member 121 from the striking position to the stop position. It is to be understood that in other examples, the motor 14 may be another form of power source, such as an engine. In the present application, for ease of description, the electric motor 14 is used for description. The electric motor 14 is an inrunner 14. The electric motor 14 includes a stator assembly 142 and a rotor assembly 143. The rotor assembly 143 includes a motor shaft 141 for outputting power, and the stator assembly 142 surrounds the motor shaft 141. The motor shaft 141 is rotatable about the motor axis 104 relative to the housing 11 to output power. It is to be understood that in other examples, the electric motor 14 may be an outrunner. One battery pack 300 is detachably mounted to the housing 11. When being mounted to the housing 11, the battery pack 300 can supply power to at least the electric motor 14 to enable the electric motor 14 to operate.

The power mechanism 20 includes a drive assembly 21, a gas spring mechanism 22, and a firing assembly 23. The drive assembly 21 is used for driving the gas spring mechanism 22 to store energy. The firing assembly 23 is formed with or connected to the striking member 121. The firing assembly 23 is configured to be movable along the direction of a third straight line 103 relative to the housing 11. When moving along the direction of the third straight line 103, the firing assembly 23 drives the striking member 121 to move along the direction of the striking straight line 101.

The gas spring mechanism 22 stores energy for driving the firing assembly 23 to move, and when releasing energy, the gas spring mechanism 22 drives the firing assembly 23 to move along the third straight line 103, thereby driving the striking member 121 to move along the direction of the striking straight line 101.

The fastener driver 100 further includes a deceleration mechanism 15 disposed between the electric motor 14 and the power mechanism 20. The deceleration mechanism 15 connects the electric motor 14 to the power mechanism 20, thereby transmitting the power outputted by the electric motor 14 to the power mechanism 20. The deceleration mechanism 15 reduces the rotational speed outputted by the electric motor 14 and outputs the reduced rotational speed. In this example, the deceleration mechanism 15 includes a first deceleration assembly 151, and the first deceleration assembly 151 uses a planet gear for deceleration. The working principle according to which a planetary gear train performs the deceleration and the deceleration implemented by the transmission mechanism have been completely disclosed to those skilled in the art. Therefore, the detailed description is omitted herein for the brevity of the specification.

The fastener driver 100 further includes a magazine assembly 191 disposed at the front end of the housing 11. The magazine assembly 191 is used for accommodating fasteners, is connected to the firing assembly 23, and can push the fasteners one by one into the striking assembly 12.

As shown in FIGS. 1 to 5, the gas spring mechanism 22 includes a cylinder 22a. The firing assembly 23 is at least partially disposed within the cylinder 22a. The cylinder 22a includes at least a first cylinder 221. Gas is provided in the first cylinder 221, the firing assembly 23 includes at least a first piston 231 that moves in the first cylinder 221 to compress the gas in the first cylinder 221 to store energy, and part or all of the first piston 231 is disposed in a first cylinder cavity 2210. The first cylinder 221 includes the first cylinder cavity 2210, and the central axis of the first cylinder cavity 2210 is configured to be a second straight line 102.

In this example, the first piston 231 includes a working side 231a in contact with the gas in the first cylinder 221 and a communication side 231b exposed to the outside. The working side 231a of the first piston 231 is within the first cylinder cavity 2210. The first cylinder cavity 2210 is at least partially formed by the inner sidewall of the first cylinder 221 and the sidewall of the working side 231a of the first piston 231. A first cylinder hole 2214 may be disposed on the surface of the first cylinder 221, and the first cylinder hole 2214 allows external gas to be replenished into the first cylinder 221 under a preset circumstance.

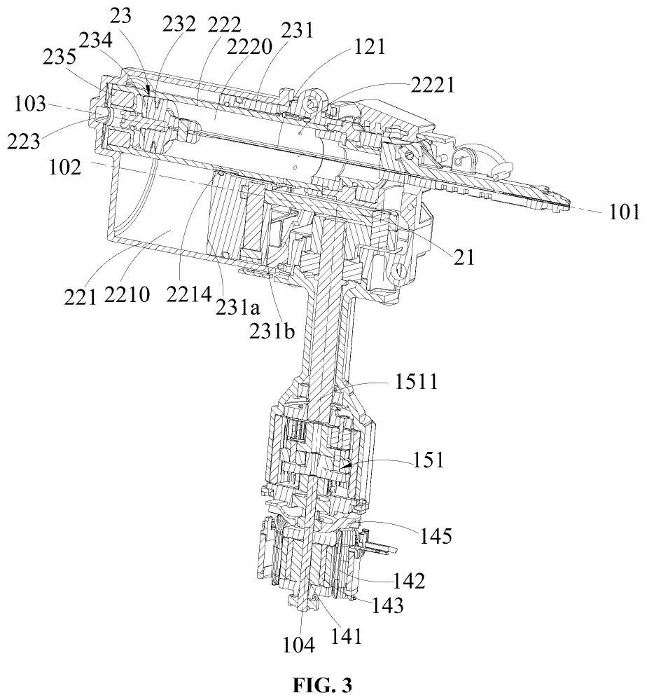

As shown in FIGS. 3 to 5, the cylinder 22a further includes a second cylinder 222. The second cylinder 222 is partially or completely disposed in the first cylinder 221. The second cylinder 222 is partially or completely disposed in the first cylinder cavity 2210. The second cylinder 222 includes a second cylinder cavity 2220, and the central axis of the second cylinder cavity 2220 coincides with the third straight line 103. In this example, the second straight line 102 and the third straight line 103 are parallel and do not coincide. In some examples, the second straight line 102 coincides with the third straight line 103. In some examples, an angle is formed between the second straight line 102 and the third straight line 103.

In some examples, the gas spring mechanism 22 further includes a communication portion 223 for causing the first cylinder cavity 2210 to communicate with the second cylinder cavity 2220, where the gas in the first cylinder cavity 2210 can enter the second cylinder cavity 2220 through the communication portion 223.

The firing assembly 23 further includes a second piston 232. The second piston 232 is disposed in the second cylinder cavity 2220. The striking member 121 is fixedly connected to the second piston 232, and the second piston 232 drives the striking member 121 to reciprocate between the top dead center or the stop position and the bottom dead center or the striking position in the second cylinder cavity 2220.

Second cylinder holes 2221 are disposed on the surface of the second cylinder 222, and part of the gas in the second cylinder cavity 2220 is released to the outside through the second cylinder holes 2221 in the case where the striking member 121 is at the striking position. After the impact on the fastener is completed, the gas may leave the second cylinder cavity 2220 and be released to the outside through the second cylinder holes 2221 when the second piston 232 is pushed by the air pressure to move forward and pass the second cylinder holes 2221.

In this example, the striking member 121 moves from the top dead center or the stop position to the bottom dead center or the striking position under the action of air pressure, and then the striking member 121 is pushed to move forward to impact the fastener. As shown in FIG. 5, after the striking member 121 moves forward to impact the fastener, the second piston 232 drives the striking member 121 to move to the stop position. In this case, the air pressure on one side of the first piston is different from the air pressure on the other side of the first piston. In this example, when the striking member 121 moves to the stop position, the electric motor 14 responds to the shutdown signal and stops moving under a set condition, thereby ensuring that the first piston 231 is stationary relative to the first cylinder 221. The air pressure on the working side 231a of the first piston 231 is not equal to the external atmospheric pressure, and the air pressure on the working side 231a of the first piston 231 is greater than the air pressure on the communication side 231b of the first piston 231. In this example, when the striking member 121 moves to the stop position and waits for the next strike, the first piston 231 has pre-compressed the gas in the first cylinder cavity 2210 so that the air pressure on one side of the first piston 231 is different from the air pressure on the other side of the first piston 231. When the striking member 121 is at the stop position, the striking member 121 is subjected to a pre-force that drives the striking member 121 to move toward the striking position. Compared with the fastener driver in the related art in which the pressure on both sides of the first piston is balanced when the striking member is at the stop position, the fastener driver in this example has a faster startup response speed.

In this example, the working side 231a of the first piston is defined as a side of the first piston that can form a sealed cavity or a sealed space with the cylinder. In this example, the first piston is separately connected to the inner wall of the first cylinder and the outer wall of the second cylinder. To ensure that the gas in the first cylinder is compressed to generate a compression force, the first piston is separately connected to the inner wall of the first cylinder and the outer wall of the second cylinder through sealing members. The surface passing through the sealing members is defined as the interface A-A, and a side of the interface that is closer to the top dead center among the two sides of the interface is defined as the working side 231a. In other words, a side located on the rear side of the interface among the two sides of the interface is the working side 231a. In other words, a side of the interface that is closer to the bottom of the first cylinder among the two sides of the interface is the working side 231a. The interface A-A is not limited to a plane. For example, in this example, the first piston includes a first sealing member 2311 connected to the inner wall of the first cylinder and a second sealing member 2312 connected to the outer wall of the second cylinder. The first sealing member 2311 and the second sealing member 2312 are staggered front and back along the direction of the second straight line 102. The interface A-A is formed by the surface passing through the first sealing member 2311 and the surface passing through the second sealing member 2312. In some examples, when the first piston has a single sealing member or the first sealing member 2311 and the second sealing member 2312 overlap along the direction of the second straight line 102, the interface A-A is a plane perpendicular to the second straight line 102. The communication side 231b of the first piston 231 is the other side of the interface A-A. It is to be understood that the communication side 231b of the first piston 231 is the opening side of the first cylinder.

In this example, the drive assembly 21 is connected to the first piston 231. When the electric motor 14 rotates about the motor axis 104, the drive assembly 21 can push the first piston 231 to reciprocate in the first cylinder cavity 2210 along the direction of the second straight line 102. In this example, the drive assembly 21 is connected to the communication side 231b of the first piston 231.

As shown in FIG. 7, the drive assembly 21 includes a crank 211, a connecting shaft 212, and a drive rod 213. The electric motor 14 is connected to an output shaft 1511 through the deceleration mechanism 15, the output shaft 1511 drives the crank 211 to rotate, the connecting shaft 212 on the crank 211 drives the drive rod 213 to reciprocate along the second straight line 102, and the drive rod 213 drives the first piston 231 to reciprocate along the direction of the second straight line 102. The drive rod 213 is connected to the communication side 231b of the first piston 231. In this example, when the electric motor 14 rotates about the motor axis 104, the axis of the output shaft 1511 is coaxial with the motor axis 104. The crank 211 is provided with two eccentric shaft holes. A first shaft hole 2111 is coaxially connected to the output shaft 1511, a second shaft hole 2112 and the first shaft hole 2111 are eccentrically disposed, and the second shaft hole 2112 is coaxially connected to the connecting shaft 212. That is to say, the output shaft 1511 and the connecting shaft 212 are eccentrically disposed. Therefore, the rotation of the electric motor 14 about the motor axis 104 is converted into the reciprocation of the first piston 231 along a second axis 102 perpendicular to the motor axis 104. The operation state of the electric motor 14 affects the position of the first piston 231 relative to the housing 11.

In some examples, the firing assembly 23 further includes an iron sheet 234 and a magnet 235. The iron sheet 234 is disposed on a side of the second piston 232 facing the communication portion 223. The magnet 235 is disposed on a side of the communication member 223 facing the second piston 232. The iron sheet 234 and the magnet 235 attract each other to maintain the position of the second piston 232. In this case, the striking member 121 is at the stop position. In other examples, the magnet 235 may be disposed on a side of the second piston 232 facing the communication portion 223, and the iron sheet 234 may be disposed on a side of the communication portion 223 facing the second piston 232.

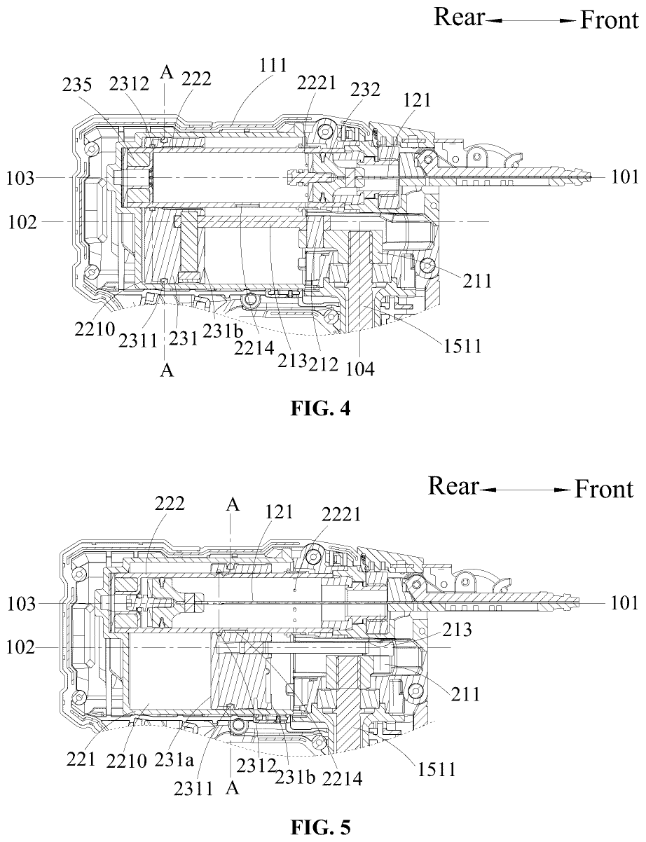

This example is an example of the power mechanism 20. When the user activates the electric motor 14, the motor shaft 141 starts to rotate about the motor axis 104. When the drive assembly 21 pushes the first piston 231 to move from front to back in the first cylinder 221 along the direction of the second straight line 102, the gas in the first cylinder cavity 2210 enters the second cylinder cavity 2220 through the communication portion 223. As the first piston 231 gradually moves toward the communication portion 223, the compression stroke of the first piston 231 for the gas in the first cylinder cavity 2210 increases, and the air pressure born by the second piston 232 also gradually increases. When the air pressure born by the second piston 232 reaches the preset threshold, the second piston 232 overcomes the attraction of the magnet 235 and the striking member moves from the top dead center (also called the stop position) to the bottom dead center (also called the striking position) under the action of the air pressure, thereby pushing the striking member 121 to move forward to impact the fastener. As shown in FIG. 4, the second piston 232 is at the bottom dead center (also called the striking position). After the impact is completed, the gas may leave the second cylinder cavity 2220 through the second cylinder holes 2221 when the second piston 232 is pushed by the air pressure to move forward and pass the second cylinder holes 2221.

After the striking member 121 moves forward to impact the fastener, the first piston 231 may be driven by the drive rod 213 to move from back to front, and at the same time, the second piston 232 is driven by the air pressure to move from front to back until the first piston 231 is driven by the drive rod 213 to the frontmost end. At the same time, the second piston 232 drives the striking member 121 to move to the stop position, and the magnet 235 and the iron sheet 234 attract each other to keep the second piston 232 and the striking member 121 at the stop position. As shown in FIGS. 3 and 5, the second piston 232 is at the top dead center (also called the stop position).

When the second piston 232 drives the striking member 121 to move to the stop position or in the process of the second piston 232 driving the striking member 121 to move to the stop position, the first piston 231 passes the first cylinder hole 2214 so that the first cylinder hole 2214 is located on the working side 231a of the first piston 231, and the first cylinder hole 2214 is at least partially located in the first cylinder cavity 2210, thereby replenishing external gas into the first cylinder 221 as shown in FIG. 3. The specific process of replenishing gas is introduced in detail below.

In this example, since the second cylinder 222 is partially disposed in the first cylinder 221, a part of the outer sidewall of the second cylinder forms the sidewall of the first cylinder 221. In this example, the first cylinder hole 2214 is at least partially formed on a portion of the outer wall of the second cylinder 222 that forms the first cylinder cavity 2210. When the first piston 231 moves forward to pass the first cylinder hole 2214 or an air inlet channel on the first piston 231 communicates with the first cylinder hole 2214, external gas may enter the first cylinder cavity 2210 through the first cylinder hole 2214, that is, external gas may reach the working side 231a of the first piston through the first cylinder hole 2214.

As shown in FIG. 5, after the gas replenishment is completed, the first piston 231 is pushed by the drive rod 213 to move from front to back in the first cylinder cavity 2210 so that the first piston 231 passes the first cylinder hole 2214 to form a sealed first cylinder cavity 2210 again, and the first piston 231 compresses the gas in the first cylinder cavity 2210. In this case, the gas in the first cylinder cavity 2210 includes the gas entering through the first cylinder hole 2214. Due to the compression of the first piston 231 for the gas, the air pressure on one side of the first piston 231 is different from the air pressure on the other side of the first piston 231 so that the air pressure on the working side 231a of the first piston 231 is greater than the external atmospheric pressure, that is, greater than the air pressure on the communication side 231b. Moreover, the air pressure on the working side 231a of the first piston 231 is less than the preset threshold at which the second piston 232 is free from the attraction of the magnet 235, thereby ensuring that the striking member 121 can still remain at the stop position after being subjected to the pre-pressure applied by the first piston 231. When the air pressure value on the working side 231a of the first piston 231 satisfies a pre-pressure threshold, the electric motor shuts down, and the first piston 231 and the first cylinder 221 remain relatively stationary.

When the electric motor is started again, the first piston 231 is pushed by the drive rod 213 to move from front to back in the first cylinder cavity 2210, the first piston 231 continues compressing the gas in the first cylinder cavity 2210, the air pressure generated by the compressed gas pushes the second piston 232 until the second piston 232 is free from the attraction of the magnet 235. The second piston 232 moves from back to front to push the striking member 121 forward to the striking position to impact the nail. Through the preceding cycle, the fastener driver can continuously fire the nails.

In this example, the power mechanism further includes a check assembly to ensure that when the air pressure on two sides of the first piston 231 is unbalanced, the electric motor 14 shuts down and the first piston 231 can remain stationary. The check assembly prevents the first piston 231 from driving the drive rod 213 to move. For example, the check assembly further includes a shaft locking assembly for transmitting power to the output shaft 1511. The shaft locking assembly allows power to be transmitted from the electric motor 14 to the output shaft 1511 while preventing power from being transmitted from the output shaft 1511 to the electric motor 14. The structure of the shaft locking assembly belongs to the relatively common technology, and the details are not repeated here. For example, the check assembly is disposed between the drive assembly 21 and the output shaft 1511, and the check assembly includes a one-way bearing to allow power to be transmitted from the output shaft 1511 to the drive assembly 21 while preventing power from being transmitted from the drive assembly 21 to the output shaft 1511. It is to be understood that the check assembly may further include other one-way transmission components. Any structure that can achieve the one-way transmission of power from the motor shaft 141 to the first piston 231 is the protection example of the check assembly of the present application.

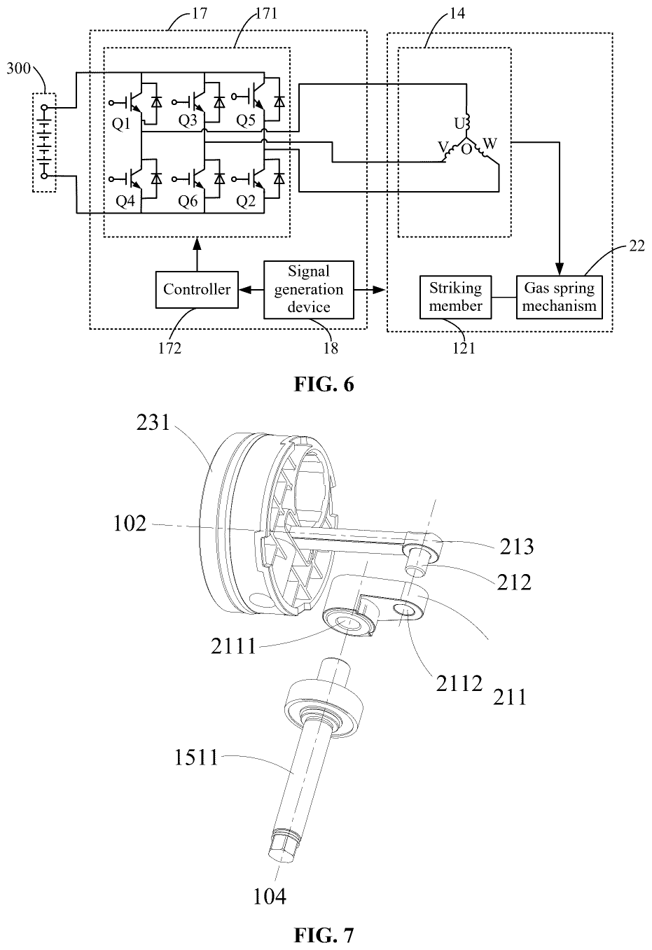

In this example, the movement of the first piston 231 is driven by the rotation of the electric motor 14, and the stop position of the first piston 231 is related to the shutdown position or shutdown time of the electric motor 14. As shown in FIG. 5, when the motor shaft 141 of the electric motor 14 stops rotating, the first piston 231 stops moving. In this example, as shown in FIG. 6, the electric motor 14 is a three-phase brushless electric motor 14. The fastener driver 100 includes a control circuit 17 for controlling the operation of the electric motor 14. For example, the control circuit 17 includes a driver circuit 171 and a controller 172. The controller 172 can at least control the operation of the electric motor 14 or limit the output of the electric motor 14. Limiting the output of the electric motor 14 includes deceleration and shutdown. The deceleration of the electric motor 14 refers to the reduction of the output rotational speed of the electric motor 14, and the shutdown of the electric motor 14 means that the electric motor 14 stops working and no longer outputs power. The electric motor 14 may shut down or shut down intermittently.

The controller 172 is disposed on a control circuit board 17a. The control circuit board 17a includes a printed circuit board (PCB) and a flexible printed circuit (FPC) board. The controller 172 adopts a dedicated control chip, for example, a single-chip microcomputer or a microcontroller unit (MCU).

In this example, after receiving the shutdown signal of the electric motor 14, the controller 172 is configured to respond to the shutdown signal at least after gas is replenished from the outside into the first cylinder 221 through the first cylinder hole 2214. That is, after receiving the shutdown signal of the electric motor 14, the controller 172 does not necessarily immediately respond to the shutdown signal to shut down the electric motor 14. In this example, the control circuit 17 further includes a signal generation device 18 for generating the shutdown signal of the electric motor. The signal generation device 18 generates the shutdown signal of the electric motor 14 when the striking member 121 is at the stop position.

In some examples, the signal generation device 18 is disposed in the transmission path from the electric motor 14 to the gas spring mechanism 22. For example, the signal generation device 18 is disposed on the drive assembly 21. For example, the signal generation device 18 is disposed on the drive rod 213. By detecting the position of the drive rod 213, whether the striking member 121 is at the stop position is determined. For example, the signal generation device 18 is disposed in the deceleration mechanism 15. In some examples, the signal generation device 18 is disposed in the transmission path from the gas spring mechanism 22 to the striking member 121. For example, the signal generation device 18 is disposed on the striking member 121 or at a position where the signal generation device 18 can sense the striking member. For example, the signal generation device 18 is disposed on the cylinder 22a or the firing assembly 23 and determines whether the striking member is at the stop position by sensing or detecting the position of the piston. The signal generation device 18 includes one or more of an infrared sensor, a Hall sensor, a photoelectric sensor, or a camera.

In some examples, when the signal generation device 18 sends the shutdown signal, the controller 172 controls the electric motor 14 to continue operating according to a preset condition, and then the electric motor 14 responds to the shutdown signal and enters a shutdown operation mode. It is to be noted that the shutdown operation mode is a preset operation mode, and the shutdown operation mode may be any one of direct shutdown, shutdown after braking, or shutdown after completing the preset fixed rotation parameter. For example, when the signal generation device 18 sends the shutdown signal, the striking member 121 is at the stop position, and the first piston 321 moves to a position such that the first cylinder hole 2214 communicates with the first cylinder cavity 2210. In this manner, gas is replenished from the outside into the first cylinder cavity 2210 through the first cylinder hole 2214. The controller 172 controls the electric motor 14 to continue to rotate, and the first piston 231 starts to move so that the first piston 231 passes the first cylinder hole 2214. In this manner, the first cylinder hole 2214 are located on the communication side 231b of the first piston 231, the first cylinder cavity 2210 is sealed again, and the first piston 231 starts to compress the gas in the first cylinder cavity 2210. In this example, when the signal generation device 18 sends the shutdown signal, the controller 172 controls the number of rotations of the electric motor 14. When the number of rotations of the electric motor 14 reaches a preset value, the pressure generated through the compression stroke of the first piston 231 for the gas in the first cylinder cavity satisfies the pre-pressure threshold. In some examples, when the signal generation device 18 sends the shutdown signal, the controller 172 may control at least one of the rotation time of the electric motor 14 or the rotation angle of the motor shaft 141.

To ensure that sufficient gas can be replenished into the first cylinder through the first cylinder hole 2214, the controller controls the electric motor to rotate at a low speed upon receiving the shutdown signal so that enough time is ensured for the gas to be replenished into the first cylinder through the first cylinder holes. For example, the rotational speed of the electric motor after the signal generation device 18 sends the shutdown signal is less than or equal to one sixth of the rotational speed of the electric motor before the signal generation device 18 sends the shutdown signal. For example, when the striking member 121 is at the stop position, the electric motor shuts down. In the case where gas is replenished into the first cylinder 221 through the first cylinder hole 2214, any component in the electric motor, the deceleration mechanism 15, or the drive assembly 21 has a theoretical gas replenishment angle. A drive wheel 1411 on the motor shaft 141 is used as an example. The drive wheel 1411 has a theoretical gas replenishment angle and theoretical gas replenishment time. When gas needs to be replenished through the first cylinder hole 2214 during the operation of the electric motor, a rotational angular velocity of the drive wheel is less than or equal to the theoretical air replenishment angle divided by the theoretical gas replenishment time. When gas needs to be replenished through the first cylinder hole 2214 during the operation of the electric motor, the rotational speed of the electric motor is less than or equal to the theoretical gas replenishment angle divided by 360, multiplied by the transmission ratio of the first deceleration assembly, and divided by the theoretical gas replenishment time.

In other alternative examples, when the signal generation device 18 sends the shutdown signal, the first piston 231 at least starts to compress the gas in the first cylinder 221. For example, the signal generation device 18 sends the shutdown signal, the first piston 231 has passed the first cylinder hole 2214, and the external replenished gas has entered the first cylinder cavity 2210 from the first cylinder hole 2214. Therefore, after the signal generation device 18 sends the shutdown signal, the electric motor 14 may directly respond to the shutdown signal and enter the shutdown operation mode. Optionally, when the striking member 121 moves to the stop position, the first piston 231 has passed the first cylinder hole 2214, that is, during the movement of the striking member 121 to the stop position, the first cylinder hole 2214 communicates with the first cylinder cavity 2210; and when the striking member 121 moves to the stop position, the first cylinder hole 2214 is already located on the communication side 231b of the first piston 231. Optionally, when the striking member 121 moves to the stop position, the first cylinder hole 2214 communicates with the cavity of the first cylinder 221, and the signal generation device 18 does not generate the shutdown signal when the striking member 121 moves to the stop position, but sends the shutdown signal after the striking member 121 moves to the stop position and remains at the stop position for a certain period.

It is to be noted that the first cylinder hole 2214 communicates with the first cylinder cavity 2210, including, for example, the first piston 231 and the first cylinder hole 2214 do not overlap, that is, the first cylinder hole 2214 is not blocked by the first piston 231 at all. For example, the second sealing member 2312 on the first piston 231 is moved closer to the front of the first cylinder hole 2214, a larger portion of the first cylinder hole 2214 is located within the movement stroke of the first piston 231, and the intake air volume is greater.

In some examples, as shown in FIG. 6, the electric motor 14 includes a rotor with a permanent magnet and three-phase stator windings U, V, and W that are commutated electronically. In some examples, the three-phase stator windings U, V, and W adopt a star connection. In some other examples, the three-phase stator windings U, V, and W adopt a delta connection. However, it is to be understood that other types of brushless electric motors are also within the scope of the present disclosure. The brushless electric motor may include fewer than or more than three phases.

The driver circuit 171 is electrically connected to the stator windings U, V, and W of the electric motor 14. The driver circuit 171 is used for transmitting the current from the battery pack 300 to the stator windings U, V, and W, thereby driving the electric motor 14 to rotate. In an example, the driver circuit 171 includes multiple switching elements Q1, Q2, Q3, Q4, Q5, and Q6. A gate terminal of each switching element is electrically connected to the controller 172 and is used for receiving a control signal from the controller 172. The drains or sources of the switching elements are connected to the stator windings U, V, and W of the electric motor 14. The switching elements Q1 to Q6 receive control signals from the controller 172 to change their respective conduction states, thereby changing the current loaded by the battery pack 300 to the stator windings U, V, and W of the electric motor 14. In an example, the driver circuit 171 may be a three-phase bridge driver circuit including six controllable semiconductor power devices (such as field-effect transistors (FETs), bipolar junction transistors (BJTs), or insulated-gate bipolar transistors (IGBTs)). It is to be understood that the preceding switching elements may be any other types of solid-state switches, such as IGBTs or BJTs.

In this example, the controller 172 controls the on or off states of the switching elements in the driver circuit 171 through the control chip. In some examples, the controller 172 controls the ratio of the on time of a drive switch to the off time of the drive switch based on a pulse-width modulation (PWM) signal. It is to be noted that the control chip may be integrated into the controller 172 or may be independent of the controller 172, and the structural relationship between a driver chip and the controller 172 may be set according to an actual situation.

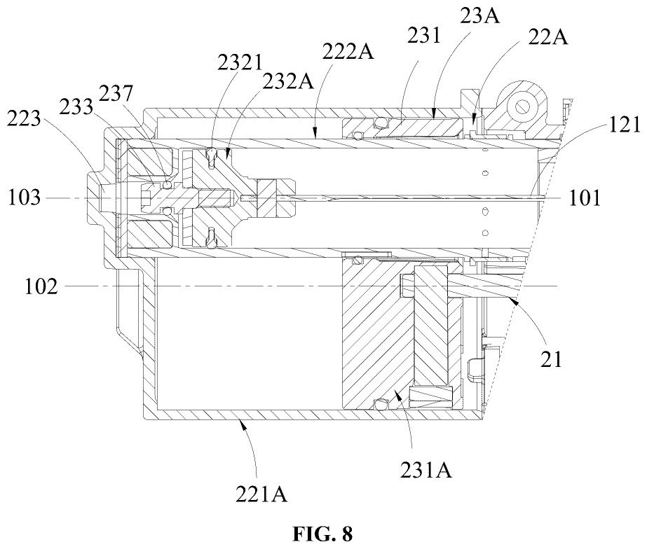

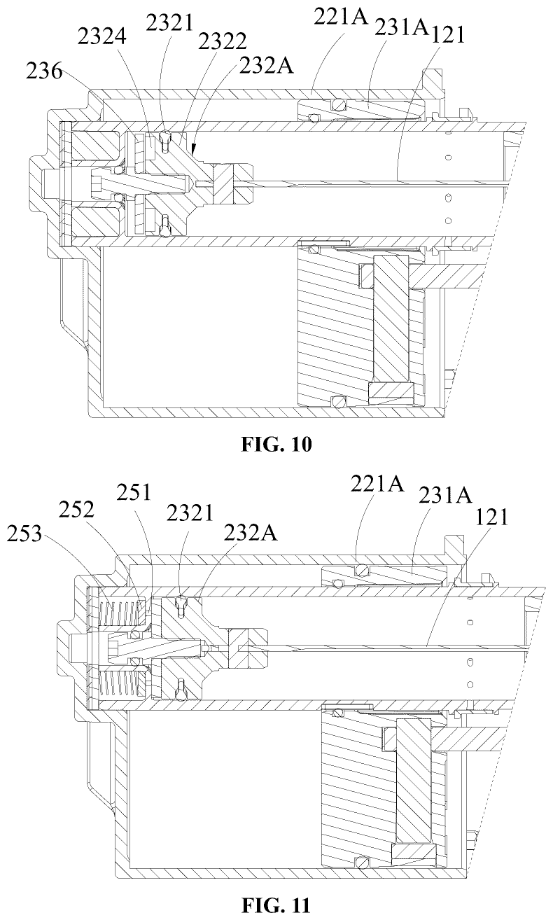

FIGS. 8 to 11 show a gas spring mechanism 22A according to another example. The second example is similar to the first example, and similar features share the same reference numerals. The following description focuses on the differences between the gas spring mechanism 22A and the gas spring mechanism 22.

In this example, the gas spring mechanism 22A includes at least an energy storage cylinder 221A and a striking cylinder 222A. The striking cylinder 222A is partially or completely disposed in the energy storage cylinder 221A, the energy storage cylinder 221A and the first cylinder 221 have similar functions, and the striking cylinder 222A and the second cylinder 222 have similar functions.

The central axis of the striking cylinder 222A is configured to be the third straight line 103. In this example, the third straight line 103 coincides with the striking straight line 101. In some examples, the third straight line 103 and the striking straight line 101 are parallel and do not coincide. In some examples, the third straight line 103 and the striking straight line 101 intersect at an included angle. The central axis of the energy storage cylinder 221A is configured to be the second straight line 102. In some examples, the second straight line 102 and the third straight line 103 are parallel and do not coincide. In some examples, the second straight line 102 coincides with the third straight line 103. In some examples, the second straight line 102 and the third straight line 103 intersect at an included angle. The striking cylinder 222A is partially or completely disposed in the energy storage cylinder 221A. In some examples, the second straight line 102 is parallel to the striking straight line 101.

A firing assembly 23A is disposed in the cylinder, and the firing assembly 23A includes a striking piston 232A and an energy storage piston 231A. The striking piston 232A is partially or completely disposed in the striking cylinder 222A. The energy storage piston 231A is disposed in the energy storage cylinder 221A. The energy storage piston 231A and the first piston 231 have similar functions, and the striking piston 232A and the second piston 232 have similar functions. An end of the drive rod 213 is connected to the energy storage piston 231A, and when the electric motor 14 rotates, the drive rod 213 can push the energy storage piston 231A to reciprocate in the energy storage cylinder 221A along the direction of the second straight line 102. The striking piston 232A can reciprocate in the striking cylinder 222A along the direction of the striking straight line 101.

The striking member 121 is fixedly connected to the striking piston 232A, and the striking piston 232A connected to the striking member 121 reciprocates between the top dead center or the stop position and the bottom dead center or the striking position in the striking cylinder 222A along the striking straight line 101. The user fills the nails into the magazine assembly 191, and the striking piston 232A pushes the striking member 121 to move and drive the nail out.

In this example, under the drive of the drive assembly 21, compressed gas that can unlock the striking piston 232A is formed in the energy storage cylinder 221A. When the drive rod 213 pushes the energy storage piston 231A to move from front to back in the energy storage cylinder 221A along the direction of the second straight line 102, the gas in the energy storage cylinder 221A enters the striking cylinder 222A. As the energy storage piston 231A gradually moves backward, the air pressure born by the striking piston 232A also gradually increases. When the air pressure born by the striking piston 232A reaches a preset threshold, the striking piston 232A is freed from the attraction of the magnetic force and/or vacuum force and moves from back to front under the action of the air pressure, that is, moves from the top dead center or the stop position to the bottom dead center or the striking position, thereby pushing the striking member 121 forward to impact the nail.

Regarding the structure of the striking cylinder 222A, in some examples, the striking cylinder 222A includes a first cylinder portion 2222 and a second cylinder portion 2223 that are connected, and the inner diameter of the first cylinder portion 2222 is greater than the inner diameter of the second cylinder portion 2223. A third piston 233 is fixed to the other end of the striking piston 232A. When the striking piston 232A is in a locked state, the striking piston 232A is located in the first cylinder portion 2222, and the third piston 233 is located in the second cylinder portion 2223.

In this example, the striking piston 232A is reset by magnetic attraction to the top dead center and maintained at the top dead center position after completing a strike. In some examples, a magnetic attraction member such as the magnet 235 is provided inside the striking cylinder 222A which forms a sealed space. The magnetic force generated by the magnet 235 is used for attracting the striking piston 232A and keeping the striking piston 232A in the locked state at the top dead center. In this example, the air pressure generated by the compressed gas from the energy storage piston 231A can overcome the magnetic force to unlock the striking piston 232A.

Optionally, an annular cavity is disposed on the outer side of the second cylinder portion 2223 of the striking cylinder 222A, and the annular magnet 235 is placed in the annular cavity. In the absence of any external force, the magnetic force generated by the magnet 235 can keep the striking piston 232A in the locked state. Optionally, the magnetic attraction member may be an electromagnet.

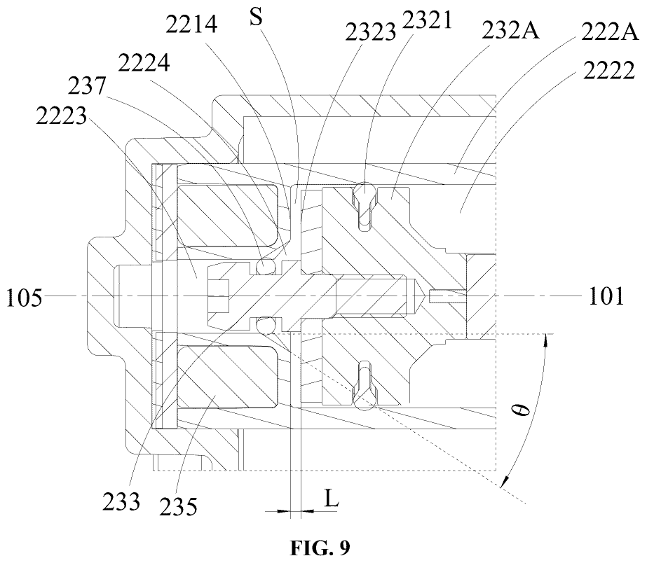

As shown in FIGS. 8 and 9, a second sealing member 2321 is sleeved on the outer circumferential side of the striking piston 232A, and a third sealing member 237 is sleeved on the outer circumferential side of the third piston 233. When the striking member 121 is in a stop state, the striking piston 232A moves backward to the top dead center or a position near the top dead center. It is to be explained that the striking member 121 being in the stop state may be understood as the state between the striking member 121 being reset after the completion of one nailing operation and the striking member 121 being driven by air pressure to perform nailing next time. In other words, the striking member 121 being in the stop state may be understood as the state of the striking member 121 when the electric motor 14 shuts down or the electric motor 14 does not apply a driving force to the drive assembly 21.

The striking piston 232A is in sealing contact with the inner wall of the striking cylinder 222A via the second sealing member 2321. When the striking member 121 is in the stop state, the striking piston 232A is held at the top dead center position by the magnet 235. In this case, the third sealing member 237 is located at a position so that the third sealing member 237 is in sealing contact with the striking cylinder 222A. After the third sealing member 237 is located in the striking cylinder 222A and in sealing contact with the striking cylinder 222A, the inner wall of the striking cylinder 222A, part of the outer sidewall of the striking piston 232A, part of the outer sidewall of the third piston 233, the second sealing member 2321, and the third sealing member 237 form a sealed space S, and the volume value of the sealed space S is limited.

During actual product application, the applicant discovers that the volume of the gas in the sealed space S is reduced due to slow leakage of the gas in the sealed space S at the contact position between the sealing member and the inner wall of the cylinder or other reasons. This causes the defined volume value of the sealed space S to change when the striking member 121 is in the stop state. The reduction in the volume of the sealed space S causes the following: when the air pressure produced by the compressed gas generated by the energy storage piston 231A unlocks the striking piston 232A, that is, when the air pressure produced by the compressed gas generated by the energy storage piston 231A drives the striking piston 232A to move forward (to the bottom dead center), not only does the magnetic force generated by the magnet 235 need to be overcome, but also the vacuum force applied to the striking piston 232A due to the reduction in the volume of the sealed space S needs to be overcome. However, in related products, when the air pressure produced by the compressed gas generated by the energy storage piston 231A drives the striking piston 232A to move, since the preceding vacuum force is not taken into account, the existence of this vacuum force causes the air pressure produced by the compressed gas generated by the energy storage piston 231A to be insufficient to drive the striking piston 232A to the bottom dead center position. Even when the volume value of the sealed space S is reduced too much and the vacuum force is too large, the striking piston 232A cannot be unlocked and driven from near the top dead center.

In this example, the applicant's main purpose is to reduce the interference caused by the vacuum force generated in the sealed space S when unlocking the striking piston 232A.

When the striking member 121 is in the stop state, a side of the striking piston 232A communicates with the outside, a sealed space is formed on the other side of the striking piston 232A, and the sealed space has an initial state and a final state. When the sealed space is in the final state, the striking piston 232A is in a stable locked state. To reduce the interference of the vacuum force when unlocking the striking piston 232A, the ratio of the difference between the volume of the sealed space S in the initial state and the volume of the sealed space S in the final state to the volume of the sealed space S in the initial state is greater than or equal to 0 and less than or equal to 0.8.

It is to be explained that the initial state of the sealed space S is the state when the third sealing member 237 is in contact with the inner wall of the striking cylinder 222A. That is, when the sealed space S is in the initial state, the volume of the gas in the sealed space has room for reduction, or in other words, the initial state of the sealed space S is the state when there is basically no vacuum in the sealed space S. The final state of the sealed space S is as follows: the striking piston 232A is in a stable locked state, that is, the striking piston 232A no longer moves toward the magnet 235 due to the reduction in the volume of the gas in the sealed space S, or in other words, a vacuum has been formed in the sealed space S and the vacuum state no longer changes. It may also be understood as that the final state of the sealed space S is the state of the sealed space when the striking member 121 is driven by the air pressure produced by the compressed gas generated by the energy storage piston 231A for the next time.

In some examples, the ratio of the difference between the volume of the sealed space S in the initial state and the volume of the sealed space S in the final state to the volume of the sealed space S in the initial state is greater than or equal to 0 and less than or equal to 0.7. In some examples, the ratio of the difference between the volume of the sealed space in the initial state and the volume of the sealed space in the final state to the volume of the sealed space in the initial state is greater than or equal to 0 and less than or equal to 0.6. In some examples, the ratio of the difference between the volume of the sealed space in the initial state and the volume of the sealed space in the final state to the volume of the sealed space in the initial state is greater than or equal to 0 and less than or equal to 0.5. In some examples, the ratio of the difference between the volume of the sealed space in the initial state and the volume of the sealed space in the final state to the volume of the sealed space in the initial state is greater than or equal to 0 and less than or equal to 0.4. In some examples, the ratio of the difference between the volume of the sealed space in the initial state and the volume of the sealed space in the final state to the volume of the sealed space in the initial state is greater than or equal to 0 and less than or equal to 0.3. In some examples, the ratio of the difference between the volume of the sealed space in the initial state and the volume of the sealed space in the final state to the volume of the sealed space in the initial state is greater than or equal to 0 and less than or equal to 0.2. In some examples, the ratio of the difference between the volume of the sealed space in the initial state and the volume of the sealed space in the final state to the volume of the sealed space in the initial state is greater than or equal to 0 and less than or equal to 0.1. The difference between the volume of the sealed space S in the initial state and the volume of the sealed space S in the final state is the volume difference of the sealed space S. The smaller the ratio of the volume difference to the volume of the sealed space S in the initial state is, the smaller the influence of the force caused by the volume difference on the driving force of the striking piston 232A is. In some examples, the difference between the volume of the sealed space S in the initial state and the volume of the sealed space S in the final state is basically 0. In this manner, the volume of the sealed space S in the initial state and the volume of the sealed space S in the final state basically do not change, so basically no vacuum is generated.

According to the preceding discussion on the principle of vacuum force generation, the smaller the difference between the volume of the sealed space in the initial state and the volume of the sealed space in the final state is, the smaller the generated vacuum force is. The smaller the ratio of the difference between the volume of the sealed space in the initial state and the volume of the sealed space in the final state to the volume of the sealed space in the initial state is, the smaller the ratio of the vacuum force to the force required to unlock the striking piston 232A is, that is, the smaller the part of the air pressure produced by the compressed gas generated by the energy storage piston 231A that needs to overcome the vacuum force is. The fastener driver 100 adjusts the ratio of the difference between the volume of the sealed space in the initial state and the volume of the sealed space in the final state to the volume of the sealed space in the initial state to reduce the vacuum force generated by the sealed space when the striking piston 232A is in the locked state, thereby increasing the ratio of the magnetic force to the adsorption force applied to the striking piston 232A in the locked state, reducing the interference caused by the vacuum force when unlocking the striking piston 232A, and making it easier to unlock the striking piston 232A.

According to the principle of vacuum formation, the vacuum force generated by the sealed space in the final state can be changed by changing the volume of the sealed space in the initial state and the volume of the sealed space in the final state. In some examples, the vacuum force generated by the sealed space in the final state is reduced by reducing the volume of the sealed space in the initial state. In some examples, the volume of the sealed space in the final state is increased to reduce the ratio of the vacuum force generated by the sealed space in the final state to the driving force required to unlock the striking piston 232A. In some examples, the interference caused by the vacuum force when unlocking the striking piston 232A is reduced by reducing the volume of the sealed space in the initial state and increasing the volume of the sealed space in the final state.

In some examples, when the striking piston 232A is in the locked state, the inner wall of the striking cylinder 222A is in sealing contact with the third piston 233 at a sealing contact position. Optionally, when the sealed space is in the initial state, the striking cylinder 222A is in contact with the third piston 233 at a first sealing contact position; and when the sealed space is in the final state, the striking cylinder 222A is in sealing contact with the third piston 233 at a second sealing contact position.

As shown in FIG. 9, the distance from a front end surface 2226 of the inner wall of the striking cylinder 222A to a rear end surface 2323 of the striking piston 232A is less than the distance from the sealing contact position to the rear end surface 2323 of the striking piston 232A. The front end surface 2226 of the inner wall of the striking cylinder 222A faces the rear end surface 2323 of the striking piston 232A. Specifically, the distance from the front end surface 2226 of the inner wall of the striking cylinder 222A to the rear end surface 2323 of the striking piston 232A is less than the distance from the first sealing contact position to the rear end surface 2323 of the striking piston 232A. Through the settings of the preceding structures, when the third piston 233 is in sealing contact with the inner wall of the striking cylinder 222A, the sealed space is formed and is in the initial state. Compared with the structures in the related art, when the sealed space is formed, the third piston 233 moves leftward, and the rear end surface 2323 of the striking piston 232A moves leftward so that the distance L between the rear end surface 2323 of the striking piston 232A and the front end surface 2226 of the inner wall of the striking cylinder 222A is reduced. In this manner, the volume of the sealed space in the initial state is reduced so that the space in which the striking piston 232A can continue moving toward the magnet 235 becomes smaller due to the reduction in the volume of the sealed space, and the volume difference between the sealed space in the initial state and the sealed space in the final state is less than the volume difference when the sealed space in the initial state is larger, which is conducive to reducing the vacuum force generated when the sealed space is in the final state and reducing the interference with unlocking.

With continued reference to FIG. 9, with the sealing contact position as the vertex of the included angle, the included angle θ between the axis of the third piston 233 and the inner wall surface of the striking cylinder 222A along the striking direction is less than 90°. The striking direction is parallel to the striking straight line 101. For example, with the first sealing contact position as the vertex of the included angle, the included angle θ between the axis of the third piston 233 and the inner wall surface of the striking cylinder 222A along the striking direction is less than 90°. In this manner, the inner wall surface of the striking cylinder 222A is shaped like a flared opening along the striking direction at the first sealing contact position so that before the third piston 233 reaches the first sealing contact position, a gap exists between the third piston 233 and the inner wall surface of the striking cylinder 222A, and the sealed space cannot be formed. In this manner, the striking piston 232A and the third piston 233 can move smoothly backward until the third piston 233 reaches the first sealing contact position.

In this example, the striking cylinder 222A further includes a third cylinder portion 2224 connected between the first cylinder portion 2222 and the second cylinder portion 2223. Along the direction from the first cylinder portion 2222 to the second cylinder portion 2223, the inner diameter of the third cylinder portion 2224 gradually decreases. When the sealed space is in the initial state, the sealing contact position is located at an end of the third cylinder portion 2224 facing the second cylinder portion 2223. In this example, the first sealing contact position is located on the third cylinder portion 2224. The striking cylinder 222A is shaped like a flared opening at the third cylinder portion 2224. The included angle θ between the edge line of the striking cylinder 222A at the third cylinder portion 2224 and the striking direction is less than 90°.

In some examples, the third cylinder portion 2224 may be a straight cylinder structure. The diameter of the third cylinder portion 2224 is greater than the diameter of the second cylinder portion 2223 and less than the diameter of the first cylinder portion 2222. In this example, the first sealing contact position may be set at an end of the second cylinder portion 2223 facing the third cylinder portion 2224. The second sealing contact position may be located within the second cylinder portion 2223.

In some examples, the third piston 233 is provided with an annular groove around the axis of the third piston 233, the third sealing member 237 is located in the annular groove, and the third sealing member 237 can move in the annular groove along the axis of the third piston 233 and stop on two opposite sidewalls of the annular groove. The axis of the third piston 233 is defined as a fifth straight line 105. In some examples, the fifth straight line 105 coincides with the striking straight line 101. In some examples, the fifth straight line 105 and the striking straight line 101 are parallel and do not coincide. In some examples, the fifth straight line 105 and the striking straight line 101 intersect at an included angle. Through the settings of the preceding structures, the sealing contact position between the third sealing member 237 on the third piston 233 and the striking cylinder 222A can remain stationary during the process of changing the sealing space from the initial state to the final state, that is, the first sealing contact position and the second sealing contact position coincide with each other. Of course, in other examples, when the third sealing member 237 and the third piston 233 are fixed, the third sealing member 237 on the third piston 233 may move backward during the process of changing the sealing space from the initial state to the final state.

As shown in FIG. 9, in some alternative examples, the rear end surface 2323 of the striking piston 232A is recessed along the striking direction to form a recessed space, and the recessed space communicates with the sealed space. In this example, due to the existence of the recessed space, the volume of the sealed space in the final state increases so that the ratio of the vacuum force generated by the sealed space in the final state to the force required to unlock the striking piston 232A can be reduced, thereby reducing the interference of the vacuum degree on the unlocking.

For example, a cavity is provided inside the striking piston 232A, and a communication channel connecting the cavity with the sealed space is provided in the striking piston 232A. For example, the cavity is annular. The annular cavity can increase the volume of the sealed space in the final state as much as possible. In addition, the third piston 233 is partially inserted into the annular cavity to ensure a fixed connection with the energy storage cylinder 221A.

Regarding the structure of the striking piston 232A, in this example, the striking piston 232A includes a piston body 2322 and a buffer 236 fixed to the rear end of the piston body 2322. The piston body 2322 is provided with a groove 2324 opening backward, and the buffer 236 and the groove 2324 form a cavity.

As shown in FIG. 11, in some alternative examples, the striking piston 232A is reset by the vacuum force to the top dead center and maintained at the top dead center position after completing one strike. In this example, a one-way exhaust valve is disposed on the inner wall of the striking cylinder 222A which forms the sealed space. The one-way exhaust valve is used for discharging the gas in the sealed space to form a vacuum space with a vacuum force. The vacuum force is used for adsorbing the striking piston 232A and keeping the striking piston 232A in the locked state. In this example, the compressed gas can overcome the vacuum force and unlock the striking piston 232A.

In this manner, the gas in the sealed space is discharged to the outside through the one-way exhaust valve during the process of changing the sealed space from the initial state to the final state, making it easier for the sealed space to reach the final state. Therefore, the striking piston 232A can smoothly reach the locked state. Regarding the structure of the one-way exhaust valve, for example, a one-way exhaust hole 251 is disposed at the end of the first cylinder portion 2222 facing the second cylinder portion 2223, the fastener driver 100 further includes a sealing gasket 252 and an elastic member 253, and the elastic member 253 is disposed between the sealing gasket 252 and the striking cylinder 222A and applies an elastic force to the sealing gasket 252 so that the sealing gasket 252 seals the one-way exhaust hole 251. When the striking member 121 is in the stop state, during the process of the striking piston 232A moving to the locked state, that is, during the process of changing the sealed space from the initial state to the final state, the pressure in the sealed space increases. After the elastic force of the elastic member 253 is overcome, the sealing gasket 252 moves away from the one-way exhaust hole 251 to open the one-way exhaust hole 251 so that the gas in the sealed space is discharged through the one-way exhaust hole 251. When the striking piston 232A moves to the locked state, the sealing gasket 252 is reset by the elastic force to a position where the sealing gasket 252 seals the one-way exhaust hole 251. In this case, a vacuum space is formed in the sealed space.

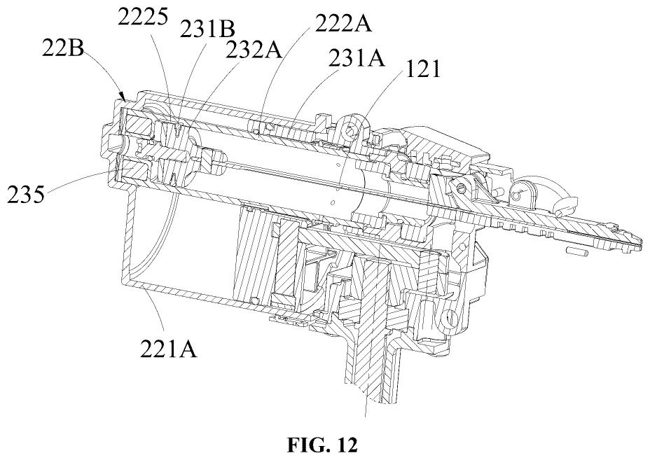

FIGS. 12 to 16 show a gas spring mechanism 22B according to the third example. The third example is similar to the second example, and similar features share the same reference numerals. The following description focuses on the differences between the gas spring mechanism 22B and the gas spring mechanism 22A.

In this example, the applicant's main purpose is to prevent a vacuum space from being formed in the sealed space when the striking piston 232A is near the top dead center, thereby preventing the vacuum force generated by the vacuum space from interfering with the unlocking of the striking piston 232A.

In some examples, when the striking member 121 is in the stop state, the striking piston 232A is in the locked state, one side of the striking piston 232A communicates with the outside, and the other side of the striking piston 232A also communicates with the outside.

In the preceding example, when the striking piston 232A is in the locked state, since the two sides of the striking piston 232A communicate with the outside, a completely sealed space cannot be formed between the striking piston 232A and the striking cylinder 222A so that a vacuum force cannot be generated between the striking cylinder 222A and the striking piston 232A. When the compressed gas unlocks the striking piston 232A, the interference caused by the vacuum force can be avoided, making it easier to unlock the striking piston 232A.

In this example, a throttle orifice is disposed on a second sealing member 2321B. The throttle orifice on the second sealing member 2321B is used for connecting the sealed space with the external environment.

In conjunction with FIGS. 14A and 14B, in some examples, the throttle orifice includes a fracture 2325 disposed on the second sealing member 2321B. Specifically, the second sealing member 2321B is a sealing ring, which is broken to form the fracture 2325. When the striking piston 232A is in the locked state, the sealed space communicates with the outside through the fracture 2325 so that a vacuum space with a vacuum force cannot be formed in the sealed space.

To reduce the impact of the fracture 2325 on the movement speed of the striking piston 232A along the first straight line 101 after the striking piston 232A is unlocked, in some examples, the opening extension direction of the fracture 2325 on the second sealing member 2321B is not parallel to the axial direction of the second sealing member 2321B. In this manner, the gas flow path in the fracture 2325 increases so that the resistance increases, and the flow velocity decreases, thereby reducing the leakage of the compressed gas generated by the energy storage piston 231A when pushing the striking piston 232A to move along the first straight line 101. Therefore, it is ensured that the striking piston 232A moves quickly along the first straight line 101.

In some examples, two sections are formed on two sides of the fracture 2325 on the second sealing member 2321B and defined as a first section 2326 and a second section 2327, and the first section 2326 and the second section 2327 are parallel. In some examples, the axis of the second sealing member 2321B is configured to be a sixth straight line 106, and the included angle α between the first section 2326 and the sixth straight line 106 is 45°. In some examples, the included angle α between the first section 2326 and the sixth straight line 106 is 20° or 60°.

In some examples, the sixth straight line 106 coincides with the first straight line 101. In some examples, the sixth straight line 106 and the first straight line 101 are parallel and do not coincide. In some examples, the sixth straight line 106 and the first straight line 101 intersect at an included angle. In some examples, the first section 2326 and the second section 2327 are not parallel.

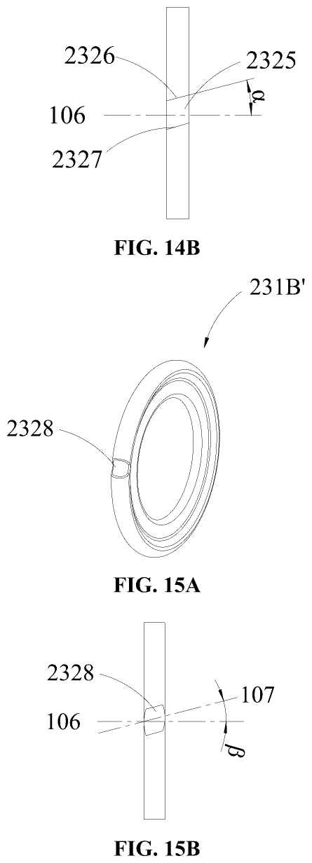

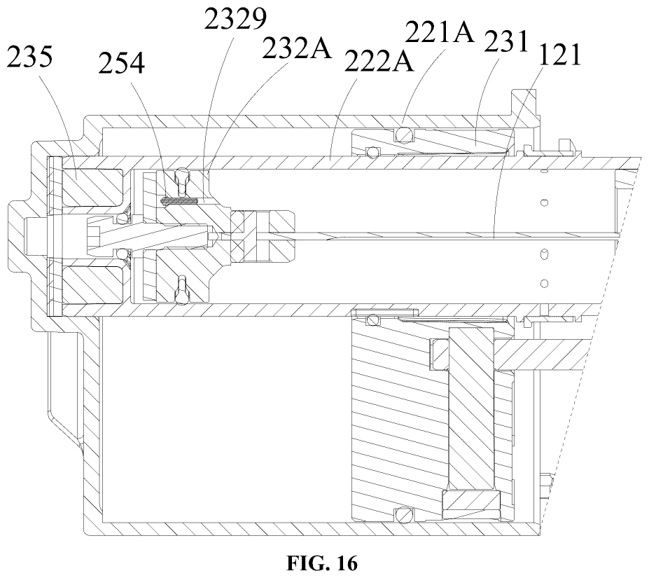

In conjunction with FIGS. 15A and 15B, regarding the structure of the throttle orifice, in some examples, the throttle orifice includes a groove 2328 disposed on the outer circumference of a second sealing member 2321B′. The groove 2328 is provided so that the second sealing member 2321B′ can be a continuous structure, which is conducive to ensuring the structural strength of the second sealing member 2321B′ and avoiding affecting the service life of the second sealing member 2321B′.

In some examples, the axis of the second sealing member 2321B′ is configured to be the sixth straight line 106, the opening extension direction of the groove 2328 on the second sealing member 2321B′ is configured to be a seventh straight line 107, and the seventh straight line 107 is not parallel to the sixth straight line 106. For example, the included angle β between the seventh straight line 107 and the sixth straight line 106 is 45°. For example, the included angle β between the seventh straight line 107 and the sixth straight line 106 is 20° or 60°. Similarly, the gas flow path through the groove 2328 increases so that the resistance increases, and the flow velocity decreases, thereby reducing the leakage of the compressed gas generated by the energy storage piston 231A when pushing the striking piston 232A to move along the first straight line 101. Therefore, it is ensured that the striking piston 232A moves quickly along the first straight line 101.

As shown in FIG. 16, other examples may be adopted in which two sides of the striking piston 232A communicate with the external environment. In some examples, the fastener driver 100 further includes a piston valve 254 disposed on the striking piston 232A. The piston valve 254 is configured to allow gas on one side of the striking piston 232A communicating with the outside to flow to the other side of the striking piston 232A. Specifically, a through mounting channel 2329 is disposed on the striking piston 232A, and the piston valve 254 is disposed in the mounting channel 2329. The piston valve 254 is configured to be a one-way throttle valve. The one-way throttle valve is provided so that gas is allowed to enter the sealed space from the outside through the striking piston 232A, but when the compressed gas enters the sealed space, gas cannot enter the external environment through the one-way throttle valve. In this manner, all the energy of the compressed gas can be used for unlocking the striking piston 232A. Moreover, since the striking piston 232A is not subjected to interference from the vacuum force, it is easier to unlock the striking piston 232A.

In some examples, the piston valve 254 is configured to be a Tesla valve. The Tesla valve is provided so that gas can smoothly enter the sealed space when the striking piston 232A is in the locked state, thereby avoiding the formation of the vacuum force in the sealed space and preventing the vacuum force from affecting the unlocking of the striking piston 232A. In addition, when the striking piston 232A is unlocked and the compressed gas enters the sealed space, the compressed gas is affected by the Tesla valve, which creates resistance to the outward flow of gas through the Tesla valve, reducing the flow velocity. In this manner, most of the compressed gas can be used for unlocking the striking piston 232A, making it easier to unlock the striking piston 232A.

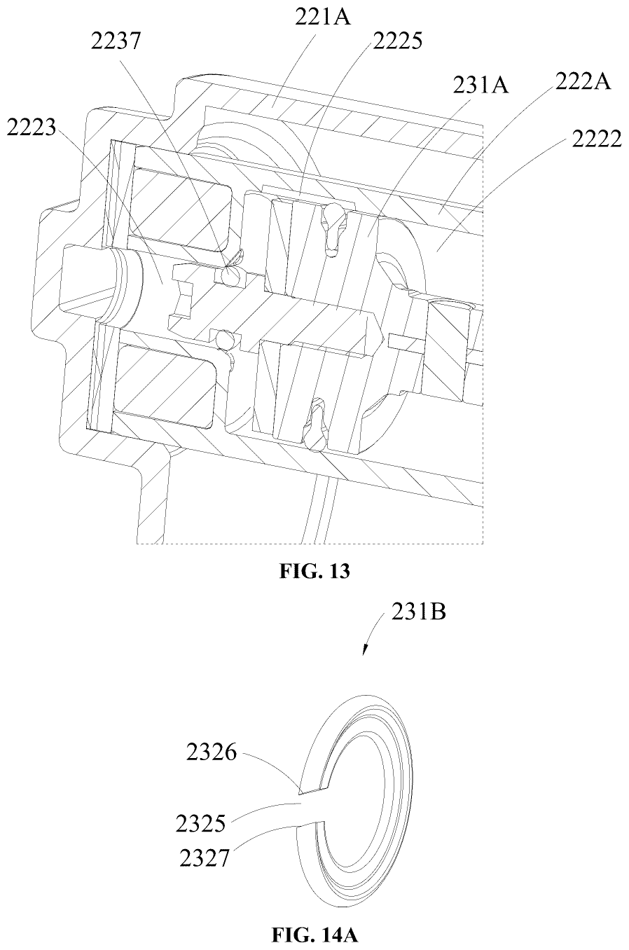

In conjunction with FIGS. 12 and 13, to avoid the formation of the vacuum force, in some examples, an exhaust channel 2225 is disposed on the inner wall of the striking cylinder 222A. When the striking piston 232A is in the locked state, the other side of the striking piston 232A communicates with the outside through the exhaust channel 2225. In this manner, when the striking piston 232A is in the locked state, two sides of the striking piston 232A communicate with each other through the exhaust channel 2225 so that gas can enter the sealed space through the exhaust channel 2225, thereby preventing a vacuum space with a vacuum force from being formed in the sealed space. In this example, the exhaust channel 2225 is disposed in the first cylinder portion 2222.

When the compressed gas enters the sealed space in the striking cylinder 222A from the energy storage piston 231A, part of the gas flows out through the exhaust channel 2225, slightly affecting the pressure of the compressed gas. Once the striking piston 232A is unlocked and moves forward a preset distance, the sealed space cannot communicate with the outside through the exhaust channel 2225. In this case, all the compressed gas can be used for pushing the striking piston 232A forward, which is conducive to ensuring the forward speed of the striking piston 232A. When the sealed space communicates with the outside through the exhaust channel 2225, the second sealing member 2321B is located between the front end and the rear end of the exhaust channel 2225, that is, the front end of the exhaust channel 2225 is located in front of the second sealing member 2321B. After the striking piston 232A moves forward a preset distance, the second sealing member 2321B passes the front end of the exhaust channel 2225.

To avoid excessive leakage of compressed gas when unlocking the striking cylinder 222A, the flow area of the exhaust channel 2225 needs to be limited, as long as it is ensured that the striking cylinder 222A can be unlocked smoothly after the compressed gas leaks. For example, during the unlocking process, the leakage of the compressed gas is less than 10%, that is, the thrust generated by the compressed gas after the leakage is not less than 90% of the thrust generated by the compressed gas before the leakage.

With continued reference to FIGS. 1 to 3, the housing 11 includes a body portion 111, a motor accommodation portion 113, and a handle portion 112. The body portion 111 is formed with a first accommodation cavity for accommodating at least part of the gas spring mechanism 22. The electric motor 14 is disposed in the motor accommodation portion 113. The handle portion 112 is held by the user to operate the fastener driver 100. The motor accommodation portion 113 and the handle portion 112 extend downward from the lower part of the body portion 111. The motor accommodation portion 113 on the front side and the handle portion 112 on the rear side extend, being basically parallel to each other.

The housing 11 further includes a coupling portion 115 to be coupled to the battery pack 300, and the battery pack 300 can be detachably mounted to the coupling portion 115. The coupling portion 115 spans between the end portion of the motor accommodation portion 113 and the end portion of the handle portion 112. Optionally, the coupling portion 115 is disposed at an end of the handle portion 112 facing away from the body portion 111. The battery pack 300 can be mounted to the coupling portion 115 along a direction intersecting the direction of the third straight line 103. In some examples, the battery pack 300 can be mounted to the coupling portion 115 along a direction parallel to the third straight line 103.

A through hole 114 for allowing the user's hand to pass through is formed between the motor accommodation portion 113 and the handle portion 112. In this example, the body portion 111 is on the upper side of the handle portion 112 and the motor accommodation portion 113, and the body portion 111 connects the handle portion 112 to the motor accommodation portion 113; the coupling portion 115 is on the lower side of the handle portion 112 and the motor accommodation portion 113, and the coupling portion 115 connects the handle portion 112 to the motor accommodation portion 113. In this manner, the body portion 111, the motor accommodation portion 113, the coupling portion 115, and the handle portion 112 are connected in sequence to surround the through hole 114. It is to be understood that in other examples, the coupling portion 115 may not be connected to the handle portion 112 and the motor accommodation portion 113. In this manner, the through hole 114 is a region between the handle portion 112 and the motor accommodation portion 113. The through hole 114 penetrates the housing 11 in the left and right direction perpendicular to the third straight line 103. When the user's hand holds the handle portion 112, the user's fingers can be at least partially located in the through hole 114, or the fingers can pass through the through hole 114 so that the user's palm and fingers can surround the handle portion 112 to hold the handle portion 112 tightly.

The fastener driver 100 further includes a trigger 192 mounted to the handle portion 112. When holding the handle portion 112, the user can operate the trigger 192 to move the trigger 192. The trigger 192 is operated by the user to activate the fastener driver 100, and the trigger 192 further includes an operation surface operated by the user. When the user holds the handle portion 112 with a hand, the user's index finger may be in contact with the operation surface to pull the trigger 192. The operation surface is the front surface of the trigger 192. In this example, the operation surface is an arc-shaped surface that fits the user's finger. The trigger 192 is disposed in the region of the through hole 114.

In some examples, the fastener driver 100 further includes an illumination assembly 162. The illumination assembly 162 is disposed on the housing 11 and used for illumination. In a working condition with dim light, the illumination assembly 162 provides auxiliary illumination light to light up the surrounding environment, which facilitates the user's operation. In some examples, the illumination assembly 162 is disposed on the body portion 111.

In this example, the trigger 192 includes a first trigger 192a corresponding to an activation switch 196a and a second trigger 192b corresponding to an illumination switch 196b for activating the illumination assembly 162. The activation switch 196a and the illumination switch 196b are disposed in the handle portion 112 separately. The activation switch 196a and the illumination switch 196b are configured to be adjacent to each other and are located on the rear side of the first trigger 192a and the rear side of the second trigger 192b, respectively. The illumination switch 196b is further configured to be activated before the activation switch 196a so that an illumination element 196 can be lit up before the fastener driver 100 is activated, thereby facilitating the illumination of a working region. Alternatively, only the illumination switch 196b may be triggered and the activation switch 196a may not be triggered so that only the illumination element 196 may be lit up to illuminate the working region, but the electric motor 14 does not need to be powered on.

In this example, a linkage assembly is disposed between the second trigger 192b and the first trigger 192a so that the first trigger 192a can be operated only after the second trigger 192b is operated, causing the illumination switch 196b to be activated before the activation switch 196a.

In some examples, the trigger 192 includes the first trigger 192a corresponding to the activation switch 196a and a safety switch 192c for locking the first trigger 192a. The first trigger 192a can be operated to activate the activation switch 196a after the safety switch 192c is operated, thereby ensuring that the activation switch 196a is not triggered by mistake. In some examples, the illumination switch 196b for activating the illumination assembly is disposed separately.

The fastener driver 100 further includes a fan 145. The fan 145 is fixedly connected to the motor shaft 141 and can rotate synchronously with the motor shaft 141. The fan 145 is mounted to the upper end of the motor shaft 141. When the fan 145 rotates, the cooling airflow that flows into the housing 11 from the outside and then flows out of the housing 11 can be generated. An airflow inlet 117 and an airflow outlet 116 are formed on the housing 11. The position of the airflow inlet 117 corresponds to the position of the fan 145, and the position of the airflow outlet 116 corresponds to the position of a circuit board assembly 17a. In this example, a capacitor with relatively high power is disposed on the circuit board assembly 17a. The position of the airflow outlet 116 also corresponds to the position of the capacitor. When the fan 145 rotates, the cooling airflow enters the housing from the airflow inlet 117, flows through the circuit board assembly 17a, and then flows out from the airflow outlet 116.

The control circuit board 17a is disposed in the coupling portion 115, and the capacitor is disposed on the upper side of the control circuit board 17a. An electrical connection terminal is disposed on the lower side of the control circuit board 17a, and the electrical connection terminal is configured to be electrically connected to the battery pack 300 so that the battery pack 300 can supply power to the electric motor 14.

In some examples, a partition for separating the electric motor 14 from the circuit board assembly 17a may further be provided on the coupling portion 115 so that the heat generated during the operation of the electric motor 14 does not reach the circuit board assembly.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A fastener driver, comprising:
a striking assembly comprising a striking member that moves from a stop position to a striking position to strike a fastener; and
a power mechanism comprising a gas spring mechanism that drives the striking member, the gas spring mechanism comprising a first cylinder having a first cylinder hole through which a gas is replenished from an outside source into the first cylinder and a second cylinder having a second cylinder hole through which the gas in the second cylinder is released to the outside source;
wherein the first cylinder communicates with the second cylinder, a first piston is disposed in the first cylinder, and an air pressure on one side of the first piston is different from an air pressure on another side of the first piston when the striking member is at the stop position.

2. The fastener driver of claim 1, wherein, when the striking member is at the stop position, the first piston remains stationary relative to the first cylinder.

3. The fastener driver of claim 1, wherein the first piston has a working side in contact with the gas in the first cylinder and a communication side exposed to the outside source, and, when the striking member is at the stop position, an air pressure on the working side of the first piston is greater than an air pressure on the communication side of the first piston.

4. The fastener driver of claim 1, wherein the power mechanism further comprises an electric motor that rotates about a motor axis to move the first piston within the first cylinder.

5. The fastener driver of claim 4, further comprising a controller that controls operation of the electric motor, wherein, after receiving a shutdown signal, the controller controls the electric motor to respond to the shutdown signal at least after the gas is replenished from the outside source into the first cylinder through the first cylinder hole.

6. The fastener driver of claim 5, further comprising a signal generation device that generates the shutdown signal.

7. The fastener driver of claim 6, wherein, when the signal generation device generates the shutdown signal, the gas is replenished into the first cylinder through the first cylinder hole.

8. The fastener driver of claim 6, wherein, when the signal generation device generates the shutdown signal, the first piston at least starts to compress the gas in the first cylinder.

9. The fastener driver of claim 6, wherein the signal generation device is disposed in a transmission path from the electric motor to the gas spring mechanism.

10. The fastener driver of claim 6, wherein the signal generation device is disposed in a transmission path from the gas spring mechanism to the striking member.

11. The fastener driver of claim 6, wherein the first piston is driven by the electric motor to move, and the stop position of the first piston is related to a shutdown position or a shutdown time of the electric motor.

12. The fastener driver of claim 6, wherein, when the signal generation device sends the shutdown signal, the controller controls a number of rotations of the electric motor.

13. The fastener driver of claim 12, wherein, when the number of rotations of the electric motor reaches a preset value, a pressure generated through a compression stroke of the first piston for the gas in a cavity of the first cylinder satisfies a pre-pressure threshold.

14. The fastener driver of claim 6, wherein, when the signal generation device sends the shutdown signal, the controller controls at least one of a rotation time of the electric motor or a rotation angle of a motor shaft.

15. The fastener driver of claim 1, wherein a part of the gas in the second cylinder is released to the outside source through the second cylinder hole when the striking member is at the striking position.

16. A fastener driver, comprising:
a striking assembly comprising a striking member that moves from a stop position to a striking position to strike a fastener; and
a power mechanism comprising a gas spring mechanism that drives the striking member, the gas spring mechanism comprising a first cylinder having a first cylinder hole through which a gas is replenished from an outside source into the first cylinder and a second cylinder having a second cylinder hole through which the gas in the second cylinder is released to the outside source;
wherein the first cylinder communicates with the second cylinder, a first piston is disposed in the first cylinder, and the first piston pre-compresses the gas in the first cylinder when the striking member is at the stop position and waits for a next strike.

17. The fastener driver of claim 16, wherein, when the striking member is at the stop position, the first piston remains stationary relative to the first cylinder.

18. The fastener driver of claim 17, wherein the first piston has a working side in contact with the gas in the first cylinder and a communication side exposed to the outside source, and, when the striking member is at the stop position, an air pressure on the working side of the first piston is greater than an air pressure on the communication side of the first piston.

19. The fastener driver of claim 16, wherein the power mechanism further comprises an electric motor that rotates about a motor axis to move the first piston within the first cylinder.

20. The fastener driver of claim 19, further comprising a controller that controls operation of the electric motor, wherein, after receiving a shutdown signal, the controller controls the electric motor to respond to the shutdown signal at least after the gas is replenished from the outside source into the first cylinder through the first cylinder hole.
